(19) United States
(12) Patent Application Publication
(10) Pub. No.: US 2012/0099303 A1
(43) Pub. Date: Apr. 26, 2012

(54) CCT MODULATING METHOD, LED LIGHT SOURCE MODULE, AND PACKAGE STRUCTURE THEREOF

(75) Inventors: Chao-Wei Li, Taipei City (TW); Ai-Lien Chang, Taichung City (TW); Hsiang-Chi Chung, Hsinchu County (TW); Ji-Feng Chen, Taipei City (TW); Hung-Lieh Hu, Hsinchu City (TW)

(73) Assignee: INDUSTRIAL TECHNOLOGY RESEARCH INSTITUTE, Hsinchu (TW)

(21) Appl. No.: 12/980,351

(22) Filed: Dec. 29, 2010

(30) Foreign Application Priority Data
Oct. 26, 2010 (TW) 99136505

(51) Int. Cl. F21V 9/00

(52) U.S. Cl. 362/231

(57) ABSTRACT

A correlated color temperature (CCT) modulating method including following steps is provided. A white LED light source is modulated to emit a first white light. At least one LED light source is modulated to emit a second white light, wherein the second white light includes at least one broad-spectrum monochromatic light. The first white light and the second white light are mixed to produce a third white light. The color rendering index (CRI) of the third white light is greater than those of the first white light and the second white light, and the color coordinates of the first white light, the second white light, and the third white light are different from each other. Furthermore, an LED light source module and a package structure thereof are also provided.

### CROSS-REFERENCE TO RELATED APPLICATION

This application claims the priority benefit of Taiwan application serial no. 99136505, filed on Oct. 26, 2010. The entirety of the above-mentioned patent application is hereby incorporated by reference herein and made a part of this specification.

### BACKGROUND

1. Technical Field

The disclosure relates to a light emitting diode (LED) light source module, and more particularly, to a variable correlated color temperature (CCT) LED light source module and a CCT modulating method and a package structure thereof.

2. Technical Art

A light emitting diode (LED) is a light emitting device fabricated of semiconductor materials, and which offers many advantages such as a small volume, a long lifespan, a low driving voltage, a low power consumption, and a good anti-vibration characteristic. Presently, LED has been broadly applied to indicator lights, illumination devices, and back light sources, etc.

White light is usually adopted for illumination purpose, and because a single LED chip offers only a narrow light emission spectrum and cannot emit white light, white light emission has to be achieved by adopting some special techniques. Presently, two techniques are usually adopted for achieving white light emission. The first technique is to excite phosphor with a blue light generated by a blue LED to generate a yellow light and then mix the yellow light and the blue light to produce a white light. The second technique is to obtain a white light by adopting a red LED, a green LED, and a blue LED at the same time.

Lights of different colors have different color temperatures. For example, when the color temperature of a light source is under 3000K, the light color turns reddish therefore brings a feeling of warmth, and when the color temperature of a light source is over 5000K, the light color turns bluish therefore brings a feeling of coolness. Thus, variation in the color temperature of a light source brings different atmosphere to a room. A conventional variable correlated color temperature (CCT) LED module is usually composed of red LEDs, green LEDs, and blue LEDs in order to allow a user to adjust the color temperature of an indoor illumination. Because each single-color LED offers only a narrow light emission spectrum therefore is a narrow-spectrum light source, the white light achieved through light mixing has a discontinuous spectrum and accordingly a low color rendering index (CRI). An illumination application usually requires a high-quality white light with a continuous spectrum (for example, a high CRI). However, it is impossible to obtain a white light with a continuous spectrum (i.e., a white light with a high CRI) by using the conventional CCT modulating technique with red LEDs, green LEDs, and blue LEDs.

### SUMMARY

A correlated color temperature (CCT) modulating method, a variable-CCT LED light source module, and a package structure thereof are introduced herein, wherein a light beam having a continuous spectrum is generated and a white light having a high color rendering index (CRI) is obtained through the CCT modulating method.

The disclosure provides a CCT modulating method including following steps. A white LED light source is modulated to generate a first white light. At least one LED light source is modulated to generate at least one broad-spectrum monochromatic light. The first white light and the broad-spectrum monochromatic light are mixed to produce a second white light, wherein the CRI of the second white light is greater than the CRI of the first white light, and the color coordinate (CC) of the first white light are different from the color coordinate of the second white light.

The disclosure provides a variable-CCT LED light source module including a white LED light source, at least one LED light source, and a control unit. The white LED light source emits a first white light. The LED light source emits at least one broad-spectrum monochromatic light. The control unit excites the white LED light source and the LED light source to emit the first white light and the broad-spectrum monochromatic light. The first white light and the broad-spectrum monochromatic light form a second white light, wherein the CRI of the second white light is greater than the CRI of the first white light, and the color coordinate of the first white light are different from the color coordinate of the second white light.

The disclosure provides a variable-CCT LED light source module including a white LED light source, at least one LED light source, and a control unit. The white LED light source emits a first white light. The LED light source emits a second white light, wherein the second white light includes at least one broad-spectrum monochromatic light. The control unit excites the white LED light source and the LED light source to emit the first white light and the second white light. The first white light and the second white light form a third white light.

The disclosure provides an LED package structure including a substrate and a plurality of LED chips. The substrate includes a plurality of recesses. The recesses include a plurality of recess depths, wherein at least part of the recess depths are different from each other. The LED chips are disposed in the recesses. Each LED chip emits a corresponding light beam. At least one first white light and at least one second white light are produced after the light beams pass through the recesses. The color coordinate of the second white light and the color coordinate of the first white light are different from each other.

The disclosure provides an LED package structure including a substrate and a plurality of LED chips. The substrate includes a plurality of recesses. The recesses include a plurality of recess depths, wherein at least part of the recess depths are different from each other. The LED chips are disposed in the recesses. Each LED chip emits a corresponding light beam. At least one first white light and at least one broad-spectrum monochromatic light are produced after the light beams pass through the recesses.

As described above, exemplary embodiments of the disclosure provide a CCT modulating method and a variable-CCT LED light source module, wherein a light with predetermined color coordinate, color temperature, or CRI and a white light with continuous optical spectrum can be achieved.

Several exemplary embodiments accompanied with figures are described in detail below to further describe the disclosure in details.

### BRIEF DESCRIPTION OF THE DRAWINGS

The accompanying drawings are included to provide further understanding, and are incorporated in and constitute a part of this specification. The drawings illustrate exemplary embodiments and, together with the description, serve to explain the principles of the disclosure.

FIG. 1A is a diagram of a variable-correlated color temperature (CCT) light emitting diode (LED) light source module according to an embodiment of the disclosure.

FIG. 1B illustrates the spectrum of a broad-spectrum monochromatic light according to an embodiment of the disclosure.

FIG. 1C illustrates the spectrum of a broad-spectrum monochromatic light according to an embodiment of the disclosure.

FIG. 2 illustrates the spectra of different color lights emitted by LED light sources in FIG. 1A.

FIG. 3 illustrates the spectra of different color lights according to another embodiment of the disclosure.

FIG. 4 illustrates the spectra of different color lights according to another embodiment of the disclosure.

FIG. 5 is a diagram of a variable-CCT LED light source module according to another embodiment of the disclosure.

FIG. 6 is a diagram illustrating the variation of color coordinates (CC) of a first white light on a Planck curve.

FIG. 7 is a diagram of an LED package structure of the variable-CCT LED light source module in FIG. 1A.

FIG. 8 is a diagram of a variable-CCT LED light source module according to another embodiment of the disclosure.

FIG. 9A is a top view of an LED package structure according to the embodiment illustrated in FIG. 8.

FIG. 9B is a cross-sectional view of the LED package structure in FIG. 9A along line aa′.

FIG. 9C is a cross-sectional view of the LED package structure in FIG. 9A along line bb′.

FIG. 10A is a top view of an LED package structure according to another embodiment of the disclosure.

FIG. 10B is a cross-sectional view of the LED package structure in FIG. 10A along line cc′.

FIG. 10C illustrates another implementation of the LED package structure in FIG. 10A.

FIG. 11A is a top view of an LED package structure according to another embodiment of the disclosure.

FIG. 11B is a cross-sectional view of the LED package structure in FIG. 11A along line dd′.

FIG. 11C is a top view of an LED package structure according to another embodiment of the disclosure.

FIG. 12 is a diagram of an LED package structure according to another embodiment of the disclosure.

FIG. 13 is a flowchart of a CCT modulating method according to an embodiment of the disclosure.

### DETAILED DESCRIPTION OF DISCLOSED EMBODIMENTS

Reference will now be made in detail to the embodiments of the disclosure, examples of which are illustrated in the accompanying drawings, wherein like reference numerals refer to the like elements throughout.

In an exemplary embodiment of the disclosure, a variable-correlated color temperature (CCT) light emitting diode (LED) light source module is provided, wherein two different white lights are mixed to achieve a white light source having different color temperatures, and one of the two white lights that are mixed includes at least one broad-spectrum monochromatic light. Thereby, the white light emitted by an LED light source module provided by an exemplary embodiment of the disclosure offers the optimal optical qualities such as a continuous optical spectrum and a high color rendering index (CRI). In addition, the color coordinate (CC) of the output white light are different from those of the two mixed white lights.

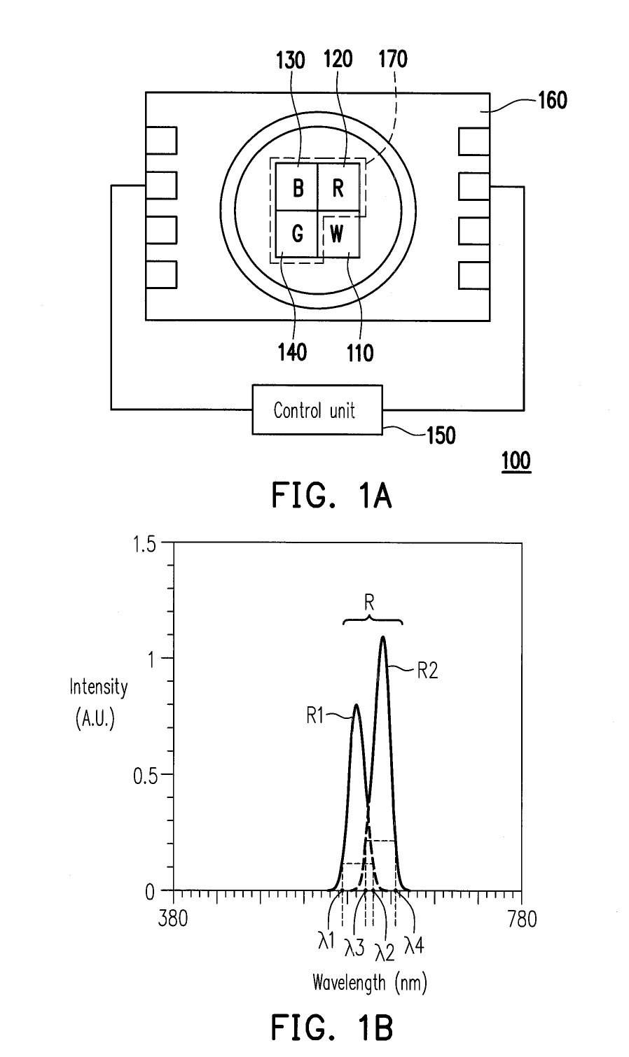

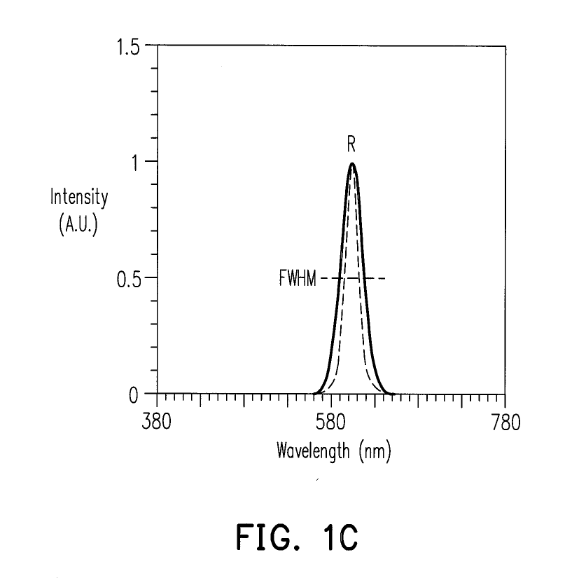

FIG. 1A is a diagram of a variable-CCT LED light source module according to an embodiment of the disclosure. Referring to FIG. 1A, in the embodiment, the variable-CCT LED light source module 100 includes a substrate 160, a white LED light source 110, a plurality of LED light sources 120, 130, and 140, and a control unit 150. The white LED light source 110 and the LED light sources 120, 130, and 140 are disposed on the substrate 160. The control unit 150 can respectively excite the LED light sources 120, 130, and 140. The white LED light source 110 and the LED light sources 120, 130, and 140 are disposed as an array or a row (or column) and are disposed adjacent to each other. However, the disclosure is not limited thereto, and the white LED light source 110 and the LED light sources 120, 130, and 140 may also be disposed nonadjacent to each other.

In the embodiment, after being excited by the control unit 150, the white LED light source 110 and the LED light sources 120, 130, and 140 respectively emit a first white light W, a red light R, a blue light B, and a green light G, wherein the symbols W, R, B, and G in FIG. 1A respectively represent different color lights emitted by the excited LED light sources. It should be noted that in the embodiment, at least one of the red light R, the blue light B, and the green light G is a broad-spectrum monochromatic light.

To be specific, assuming that the red light R is a broad-spectrum monochromatic light, the LED light source 120 includes a plurality of narrow-spectrum red LED light sources. After being excited by the control unit 150, the red LED light sources emit a plurality of narrow-spectrum red lights, and the broad-spectrum red light R is produced after at least two of the narrow-spectrum red lights are mixed, as shown in FIG. 1A.

Similarly, in another embodiment, the LED light source module 100 may also include a broad-spectrum green light G or a broad-spectrum blue light B, which will not be described herein.

FIG. 1B illustrates the spectrum of a broad-spectrum monochromatic light according to an embodiment of the disclosure. Referring to FIG. 1A and FIG. 1B, in the embodiment illustrated in FIG. 1A, the LED light source 120 includes two narrow-spectrum red LED light sources, and a broad-spectrum red light R is produced after two narrow-spectrum red lights are mixed, as shown in FIG. 1B.

Referring to FIG. 1B, the broad-spectrum red light R includes a first red light R1 and a second red light R2. In the embodiment, regarding the first red light R1, the wavelengths corresponding to 1/10^{th} of the intensity of the peak wavelength thereof are respectively λ1 and λ2, and the corresponding spectrum width is the wavelength λ2 minus the wavelength λ1. While regarding the second red light R2, the wavelengths corresponding to 1/10^{th} of the intensity of the peak wavelength thereof are respectively λ3 and λ4, and the corresponding spectrum width is the wavelength λ4 minus the wavelength λ3. Herein λ2>λ1, λ4>λ3, λ4>λ1, and λ2≧λ3.

Thereby, in an exemplary embodiment of the disclosure, a broad-spectrum monochromatic light produced by mixing two narrow-spectrum monochromatic lights is defined as: the wavelengths corresponding to 1/10^{th} of the intensity of the peak wavelength of the first monochromatic light are respectively λ1 and λ2, and the wavelengths corresponding to 1/10^{th} of the intensity of the peak wavelength of the second monochromatic light are respectively λ3 and λ4, wherein λ2>λ1, λ4>λ3, λ4>λ1, and λ2≧λ3.

Additionally, in the embodiment illustrated in FIG. 1A, the broad-spectrum monochromatic light is not limited to being produced by a plurality of narrow-spectrum LED light sources. Instead, the broad-spectrum monochromatic light may also be produced through phosphor conversion.

FIG. 1C illustrates the spectrum of a broad-spectrum monochromatic light according to an embodiment of the disclosure. In the embodiment, the broad-spectrum red light R is produced through phosphor conversion. For example, if a wavelength conversion layer is fabricated by using red phosphor, the LED light source 120 may include a UV LED chip (not shown). After being excited by the control unit 150, the UV LED chip generates an UV light beam, and the spectrum of the UV light beam before it passes through the wavelength conversion layer is as indicated by the dotted line in FIG. 1C, and the spectrum of the broad-spectrum red light R produced after the UV light beam passes through the wavelength conversion layer is as indicated by the real line in FIG. 1C.

Thereby, if the phosphor conversion technique is adopted for producing a broad-spectrum monochromatic light in an exemplary embodiment of the disclosure, a monochromatic light can be defined as the broad-spectrum monochromatic light as long as the full width half maximum (FWHM) of the monochromatic light after it is converted is greater than the FWHM thereof before it is converted.

Similarly, in the embodiment, the LED light sources 130 and 140 may also respectively include blue phosphor and green phosphor and UV LED chips for respectively producing the broad-spectrum blue light B and the broad-spectrum green light G.

Additionally, if broad-spectrum monochromatic lights in other colors are to be produced, the LED light sources 120, 130, and 140 of the LED light source module 100 can be replaced by using other LED light sources that emit other different color lights. For example, an LED light source having yttrium aluminium garnet (YAG) phosphor and a blue LED chip may be adopted for emitting a broad-spectrum yellow light.

On the other hand, in the embodiment, it can be considered that the LED light source module 100 performs color tuning by using a first white light and a second white light, wherein the CRI of the obtained third white light is greater than the CRI of the first white light and the CRI of the second white light, and the color coordinates of the first white light, the second white light, and the third white light are different from each other.

To be specific, different color lights emitted by the LED light sources 120, 130, and 140 when the LED light sources 120, 130, and 140 are excited by the control unit 150 can be considered as a second white light emitted by another white LED light source 170. In the embodiment, because at least one of the red light R, the blue light B, and the green light G is a broad-spectrum monochromatic light, the second white light emitted by the white LED light source 170 includes at least one broad-spectrum monochromatic light. Besides, the broad-spectrum monochromatic light (for example, the broad-spectrum blue light B) may be produced by using two monochromatic lights having different spectra, the broad-spectrum red light R may be produced by using a UV LED and red phosphor through phosphor conversion, and the second white light may be produced by using foregoing blue light B and red light R and a green light G (either a broad-spectrum monochromatic light or a narrow-spectrum monochromatic light, wherein how to produce the broad-spectrum monochromatic light has been described above therefore will not be described herein). In other words, even though the second white light includes at least one broad-spectrum monochromatic light, a more continuous spectrum and accordingly a higher CRI of the second white light can be achieved by using more broad-spectrum monochromatic lights since the spectrum of the second white light is obtained by joining the spectra of the broad-spectrum monochromatic lights.

In the embodiment, the control unit 150 modulates at least one of the currents or the pulse width parameters of the white LED light source 110 and the LED light sources 120, 130, and 140 to emit the corresponding color lights.

Herein modulating the current of an LED light source means controlling the brightness of the light emitted by the LED light source by adjusting the intensity of the current supplied to the LED light source, and modulating the pulse width of an LED light source means driving the LED light source to emit light through pulse width modulation (PWM) and controlling the brightness of the light emitted by the LED light source by adjusting the total high-pulse-level time during a unit time.

It should be noted that the control unit 150 may modulate one of a combination of the currents and pulse width parameters and individually control the currents or pulse widths while modulating the LED light sources or the white LED light source. However, aforementioned modulation parameters are not intended to limit the scope of the disclosure.

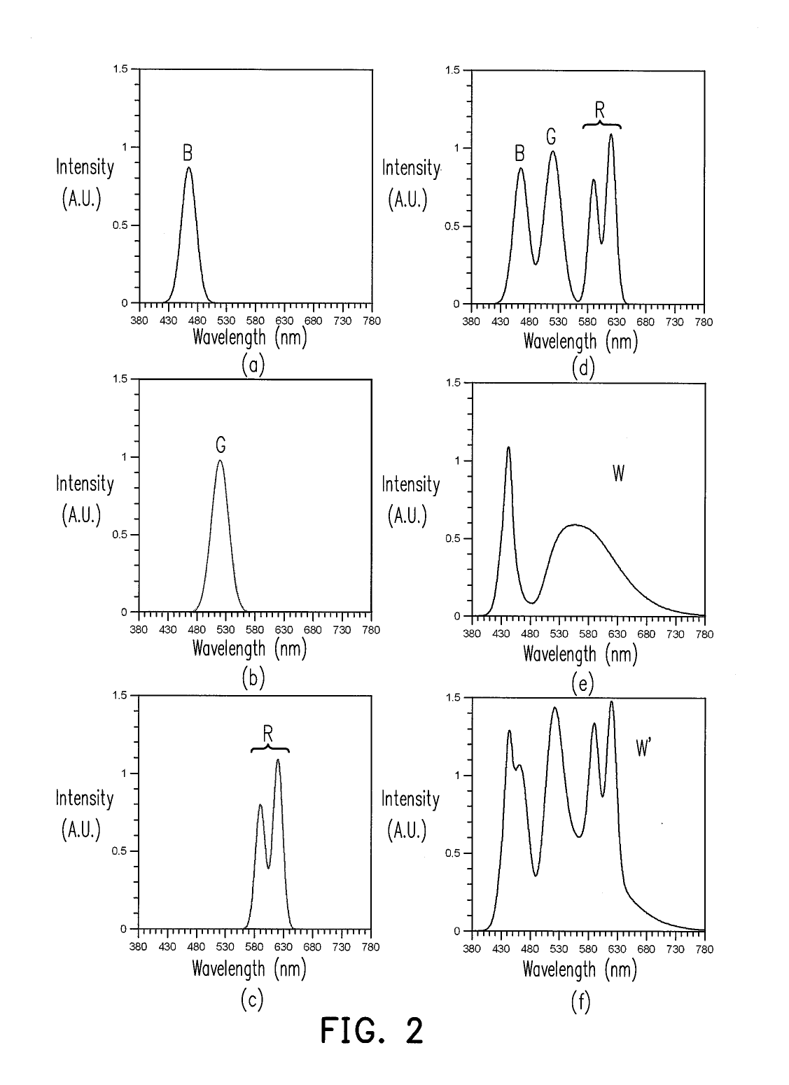

FIG. 2 illustrates the spectra of different color lights emitted by the LED light sources in FIG. 1A, wherein each abscissa represents the wavelength (in unit of nm), and each ordinate represents the light intensity (in unit of relative intensity (A.U.).

Referring to FIG. 1A and FIG. 2, in the embodiment, after being excited by the control unit 150, the white LED light source 110 and the LED light sources 120, 130, and 140 respectively emit a first white light W, a red light R, a blue light B, and a green light G, and the spectra of these lights are respectively illustrated in FIG. 2(e), FIG. 2(c), FIG. 2(a) and FIG. 2(b). In the embodiment, the red light R is a broad-spectrum monochromatic light produced by mixing two narrow-spectrum monochromatic lights, as shown in FIG. 1B. In other embodiments, the broad-spectrum red light R may be a broad-spectrum red light produced through phosphor conversion.

FIG. 2(d) illustrates the spectrum of a light produced by mixing the color lights in FIGS. 2(a)-2(c), the CCT of the light is 5276K, and the CRI thereof is 69.84. On the other hand, the spectrum illustrated in FIG. 2(d) can be considered as the spectrum of a second white light having a CCT of 5276K and a CRI of 69.84.

On the other hand, in the embodiment, the white LED light source 110 may be a phosphor conversion white LED, a white LED chip, or produce a white light by mixing a blue light, a green light, and a red light. In the embodiment, the first white light W emitted by the white LED light source 110 has a spectrum as that illustrated in FIG. 2(e). In the embodiment, the CCT of the first white light W is 5270K, the CRI thereof is 69.7, and the spectrum thereof is between 400 nm and 850 nm.

It should be noted that in the embodiment, the CRI of the first white light W emitted by the white LED light source 110 is smaller than or equal to 85. However, the disclosure is not limited thereto, and in another embodiment, the white LED light source 110 may also be a high-CRI white LED light source. In this case, the CRI of the first white light W is greater than or equal to 80.

After the white LED light source 110 and the LED light sources 120, 130, and 140 are respectively excited, the control unit 150 mixes the first white light W and the second white light (produced by mixing the red light R, the blue light B, and the green light G) to produce a third white light W′. Herein the first white light and the second white light may be mixed by directly overlapping the transmission paths of the first white light and the second white light or by using light guiding media, wherein the light guiding media may be (but not limited to) a lens and a light guide. In addition, the first white light and the second white light may also be reflected by using a reflective surface to be mixed.

The spectrum of the third white light W′ is illustrated in FIG. 2(f). It can be observed in FIG. 2(f) that the CCT of the third white light W′ is 5273K, and the CRI thereof is 93.3. Namely, in the embodiment, the CRI of the mixed third white light is greater than the CRI of the first white light W and the CRI of the second white light.

Thus, in the embodiment, the LED light source module 100 performs color tuning by using a constant first white light W and a second white light obtained by mixing a red light R, a blue light B, and a green light G to produce a third white light W′ having a high CRI. Moreover, regarding an illumination application, if a high-quality white light is required, the LED light source module 100 can supply a light with a continuous spectrum (i.e., a white light having a high CRI) through the CCT modulating method in the embodiment.

It has to be noted that in the embodiment illustrated in FIG. 1A, the variable-CCT LED light source module 100 includes the white LED light source 110 and the LED light sources 120, 130, and 140 in different colors. However, the disclosure is not limited thereto, and in another embodiment, the LED light sources may also be broad-spectrum monochromatic LED light sources in the same color.

Namely, the LED light sources 120, 130, and 140 in FIG. 1A may respectively be broad-spectrum blue LED light sources having different peak wavelengths, and these broad-spectrum blue LED light sources may produce broad-spectrum blue lights through phosphor conversion. Herein the third white light modulated by the control unit also has a CRI, and because the third white light contains a higher percentage of blue light, it is usually referred to as a cool white light.

In other words, according to the actual design requirement, the LED light sources may be designed into broad-spectrum same-color LED light sources having different peak wavelengths in order to allow the modulated third white light to have a high CRI and a corresponding CCT.

In addition, the LED light sources 120, 130, and 140 in FIG. 1A may also be designed into broad-spectrum monochromatic LED light sources in two different colors, and these broad-spectrum monochromatic LED light sources may produce broad-spectrum monochromatic lights through phosphor conversion.

Moreover, in the embodiment illustrated in FIG. 1A, the LED light sources 120, 130, and 140 may also be designed into narrow-spectrum same-color LED light sources, and the narrow-spectrum same-color lights emitted by these narrow-spectrum same-color LED light sources may also be mixed to produce a broad-spectrum monochromatic light. Herein the broad-spectrum monochromatic light may also be mixed with the first white light to produce a third white light having a high CRI.

The LED light sources 120, 130, and 140 may be designed into narrow-spectrum blue LED light sources that emit light in the same color and with different peak wavelengths, and the narrow-spectrum blue lights emitted by these narrow-spectrum blue LED light sources may be mixed to produce a broad-spectrum blue light. Furthermore, the broad-spectrum blue light is mixed with the first white light to produce a third white light having a high CRI.

If the LED light sources 120, 130, and 140 emit lights in different colors, each of the LED light sources may further include a plurality of narrow-spectrum same-color LED light sources.

For example, the LED light source 130 may include a plurality of narrow-spectrum blue LED light sources, and the narrow-spectrum blue lights emitted by the narrow-spectrum blue LED light sources may be mixed to allow the LED light source 130 to emit a broad-spectrum blue light.

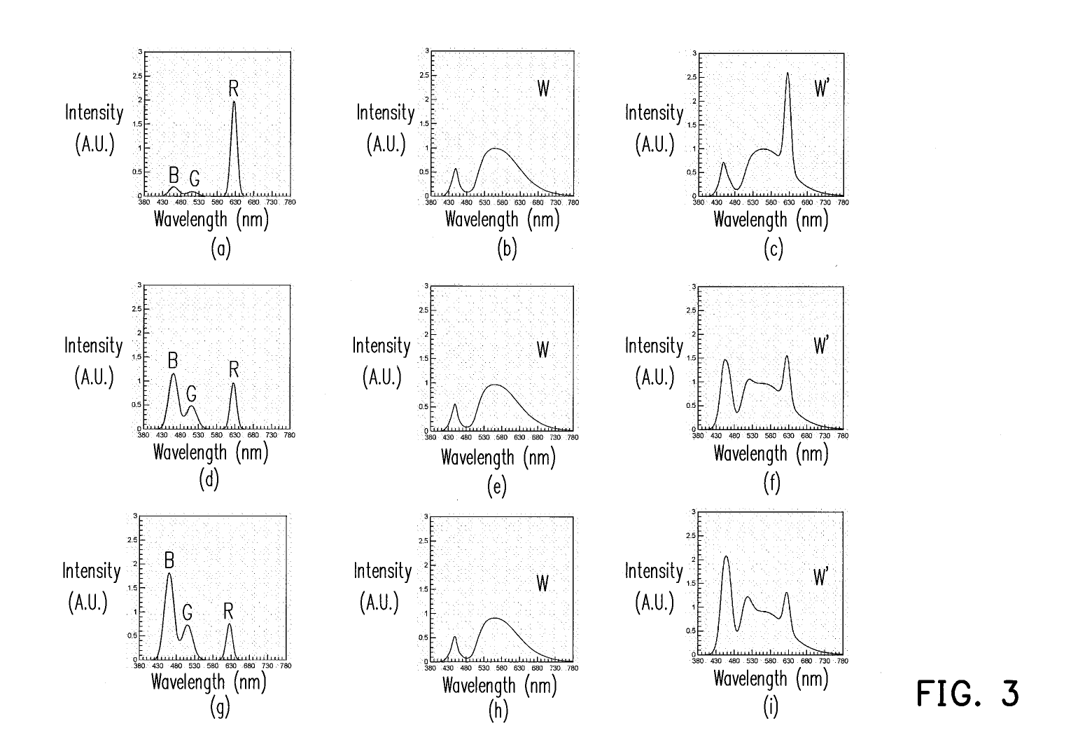

FIG. 3 illustrates the spectra of different color lights according to another embodiment of the disclosure, wherein the spectra of the lights emitted by the LED light sources in FIG. 1A are respectively illustrated.

Referring to FIG. 1A and FIG. 3, if the LED light sources 120, 130, and 140 emit lights of different colors, the control unit 150 modulates at least one of the currents and the pulse width parameters of the monochromatic LED light sources 120, 130, and 140 to change the ratio between different color lights, so as to produce different second white light. Thereafter, the second white light is mixed with the first white light W to produce a third white light W′ having different CCT and a high CRI.

Referring to FIG. 3(a)-FIG. 3(c), after the LED light sources 120, 130, and 140 are excited, the spectrum of the broad-spectrum monochromatic light emitted by the three LED light sources is as that illustrated in FIG. 3(a). As shown in FIG. 3(a), through the modulation of the control unit 150, the red light R takes a much higher percentage than the blue light B and the green light G, and the corresponding second white light has a CCT of 2892K and a CRI of 10.17. Besides, FIG. 3(b) illustrates the spectrum of the first white light emitted by the white LED light source 110.

Thus, the control unit 150 mixes foregoing first white light W and second white light to obtain the third white light W′. The spectrum of the third white light W′ is illustrated in FIG. 3(c), the CCT thereof is 3005K, and the CRI thereof is 92.2.

Additionally, referring to FIG. 3(d)-FIG. 3(f), after the LED light sources 120, 130, and 140 are excited, the spectrum of the broad-spectrum monochromatic light emitted by the three LED light sources is as that illustrated in FIG. 3(d). As shown in FIG. 3(d), through the modulation of the control unit 150, the percentages of the red light R and the blue light B are the same but are higher than that of the broad-spectrum green light G. Herein the CCT of the corresponding second white light is 3436.6K, and the CRI thereof is 23.17. Besides, FIG. 3(e) illustrates the spectrum of the first white light emitted by the white LED light source 110, which is the same as that illustrated in FIG. 3(b).

Similarly, the control unit 150 mixes foregoing first white light W and second white light to produce the third white light W′. The spectrum of the third white light W′ is illustrated in FIG. 3(f), the CCT thereof is 5025K, and the CRI thereof is 95.7.

Moreover, referring to FIG. 3(g)-FIG. 3(i), after the LED light sources 120, 130, and 140 are excited, the spectrum of the broad-spectrum monochromatic light emitted by the three LED light sources is as that illustrated in FIG. 3(g). As shown in FIG. 3(g), through the modulation of the control unit 150, the percentages of the red light R and the green light G are the same but are lower than that of the blue light B. Herein the CCT of the corresponding second white light is 3436.7K, and the CRI thereof is 29.26. Besides, FIG. 3(h) illustrates the spectrum of the first white light emitted by the white LED light source 110, which is the same as those illustrated in FIG. 3(b) and FIG. 3(e).

Similarly, the control unit 150 mixes foregoing first white light W and second white light to produce the third white light W′. The spectrum of the third white light W′ is illustrated in FIG. 3(i), the CCT thereof is 6993K, and the CRI thereof is 95.5.

It can be understood based on foregoing spectra illustrated in accompanying drawings, in the embodiment, the spectrum of the first white light is not changed, and the control unit 150 can change the percentages of different color lights in the second white light by altering at least one of the currents and the pulse width parameters of the LED light sources 120, 130, and 140 according to different design requirement. After the second white light having different color light ratio is mixed with the constant first white light, a third white light having different CCT and a high CRI can be produced according to the actual requirement.

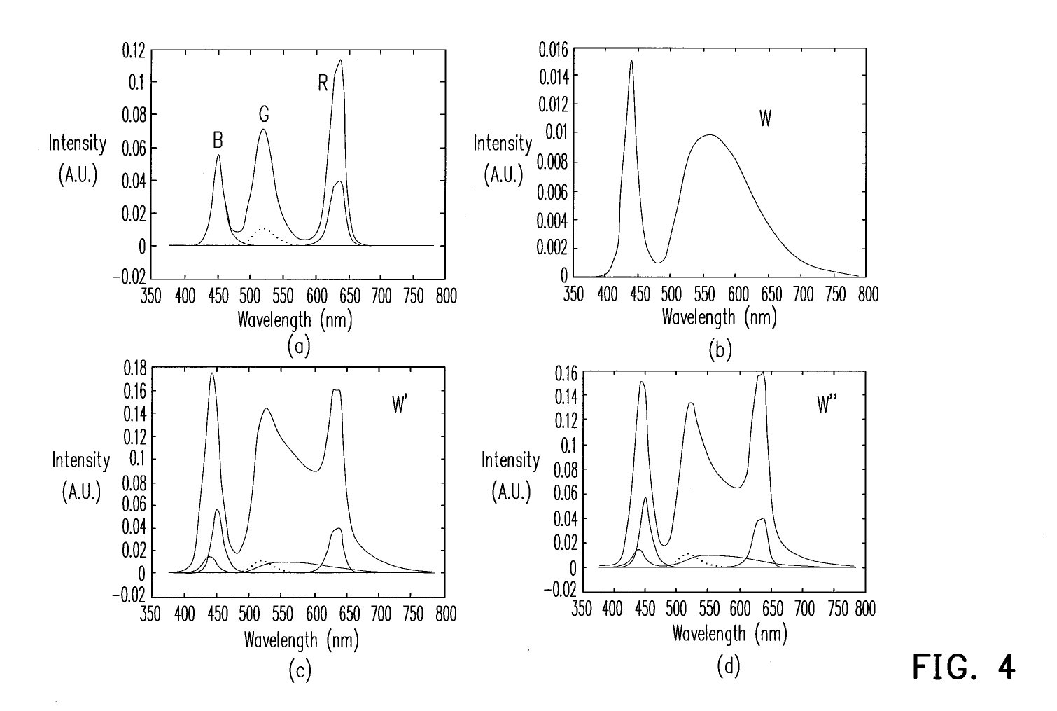

FIG. 4 illustrates the spectra of different color lights according to another embodiment of the disclosure, wherein the spectra of the lights emitted by the LED light sources in FIG. 1A are respectively illustrated.

Referring to FIG. 1A and FIG. 4, in the embodiment, after the various-color LED light sources 120, 130, and 140 and the white LED light source 110 are excited, the spectra of the second white light and the first white light are respectively as those illustrated in FIG. 4(a) and FIG. 4(b). Herein FIG. 4(a) illustrates the spectrum of the second white light, and the CRI of the second white light is 35. FIG. 4(b) illustrates the spectrum of the first white light W, and the CRI of the first white light W is 70.

In the embodiment, the control unit 150 modulates at least one of the currents and the pulse width parameters of the LED light sources 120, 130, and 140 according to the actual requirement so as to change the ratio between different color lights.

For example, referring to FIG. 4(b), the first white light W has a lower CRI because the red light R takes a low percentage therein. Accordingly, when the CCT of the second white light is adjusted to be the same as that of the first white light, the control unit 150 can modulate at least one of the current or the pulse width parameter of the broad-spectrum red LED light source 120 to increase the intensity of the red light R. Thus, the CRI of the modulated third white light W′ is enhanced within the spectrum of red light so that the third white light W′ has a higher CRI (CRI=84), as shown in FIG. 4(c). In addition, the third white light W′ has 3715 lumens.

Additionally, when the CCT of the second white light is adjusted to be the same as that of the first white light according to the actual requirement and a third white light W′ with a higher number of lumens is to be produced, the control unit 150 can modulate at least one of the current and the pulse width parameter of the green LED light source 140 to enhance the intensity of the green light G, so as to increase the percentage of the green light G. Accordingly, the modulated third white light W″ has a CRI=77, and the number lumens thereof is drastically increased to 5473, as shown in FIG. 4(d).

In other words, in the embodiment, the CRI of the third white light may be increased by increasing the percentage of the red light R in the second white light, and the number of lumens of the third white light may be increased by increasing the percentage of the green light G in the second white light. Thus, in an embodiment of the disclosure, color tuning can be accomplished by mixing an adjustable second white light and a constant first white light.

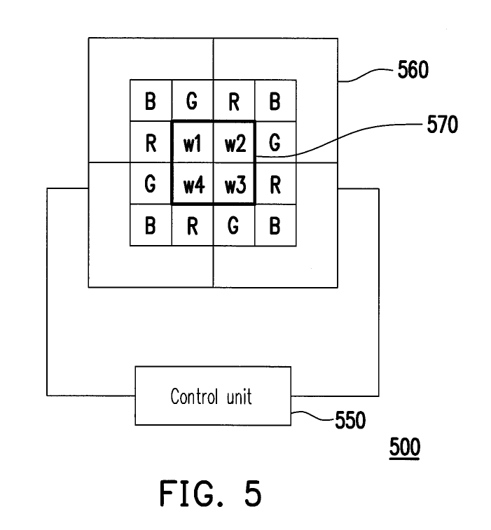

FIG. 5 is a diagram of a variable-CCT LED light source module according to another embodiment of the disclosure. Referring to FIG. 5, in the embodiment, four light source blocks of the LED light source module 100 in FIG. 1A are disposed on the substrate 560 of the LED light source module 500, wherein the symbols R, B, and G in FIG. 5 respectively represent the colors of lights emitted by the light sources blocks.

It should be noted that those light source blocks marked with the same symbol emit lights of the same color. However, the peak wavelengths of the lights emitted by these light source blocks may be different.

In the embodiment, the LED light source module 500 includes a plurality of white LED light sources, and the white lights emitted by these white LED light sources are modulated to produce a first white light. For example, in the embodiment, the white lights W1, W2, W3, and W4 emitted by the light source block 570 have four different color coordinates (X₁, Y₁), (X₂, Y₂), (X₃, Y₃), and (X₄, Y₄) on the CIE chromaticity diagram. The first white light can be produced by mixing the white lights W1, W2, W3, and W4. Thus, in the embodiment, the color coordinate of the first white light may be moved within a range enclosed by the color coordinates of foregoing four white lights or on a Planck curve in the CIE chromaticity diagram according to the design requirement to make the obtained first white light a Planck curve variable white light. The white lights W1, W2, W3, and W4 may be adjacently disposed as an array. A plurality of LED light sources (for example, a red light R, a green light G, and a blue light B) are sequentially arranged around the white lights W1, W2, W3, and W4.

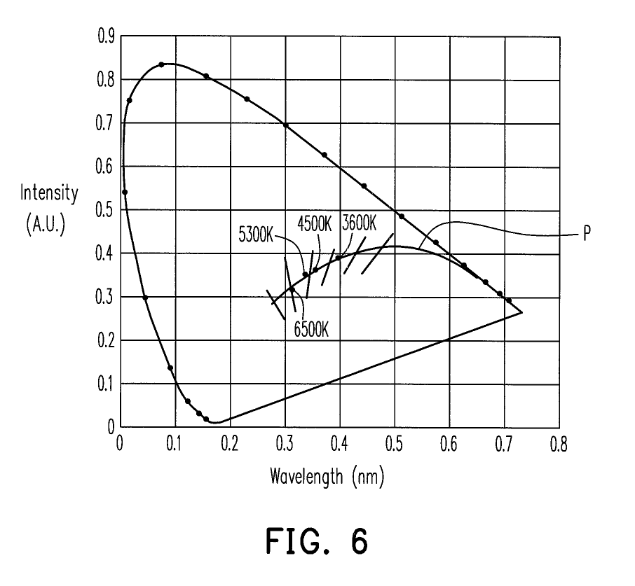

FIG. 6 is a diagram illustrating the variation of color coordinates (CC) of a first white light on a Planck curve. Referring to FIG. 5 and FIG. 6, in the embodiment, the color coordinate of the first white light obtained by mixing the white lights W1, W2, W3, and W4 may be changed within the range enclosed by the color coordinates of the four white lights or on the Planck curve (different position is corresponding to different white light CCT) according to the actual requirement. FIG. 6 illustrates different CCT (for example, 6500K, 5300K, 4500K, or 3600K) of the first white light obtained by modulating the white lights W1, W2, W3, and W4. In other words, in the embodiment, the first white light W has a variable CCT.

On the other hand, in the embodiment, the LED light source module 500 includes a plurality of LED light sources, such as blue LED light sources. The blue lights B emitted by the LED light sources may have the same or different peak wavelengths and the same or different FWHMs. In another embodiment, the blue light emitted by each LED light source may also be a narrow-spectrum blue light.

Regardless of the optical characteristics of the blue light, green light, and red light, in the embodiment, the color lights emitted by the LED light sources include at least one broad-spectrum monochromatic light so that they can be mixed with the first white light to produce a third white light having a high CRI. How the broad-spectrum monochromatic light is produced has been described above therefore will not be described herein.

In the embodiment, the first white light produced by the LED light source module 500 has a variable CCT, and which is mixed with at least one broad-spectrum monochromatic light to produce a third white light having a high CRI. On the other hand, in the embodiment, all the red light R, the green light G, and the blue light B are mixed to produce a second white light, and the second white light is further mixed with the first white light to perform color tuning.

Additionally, in the embodiment, the white lights W1, W2, W3, and W4 emitted by the light source block 570 may also be white lights having the same CCT such that the illumination brightness can be increased. The white lights W1, W2, W3, and W4 are then mixed with a broad-spectrum red light R, green light G, or blue light B to achieve a color tuning purpose.

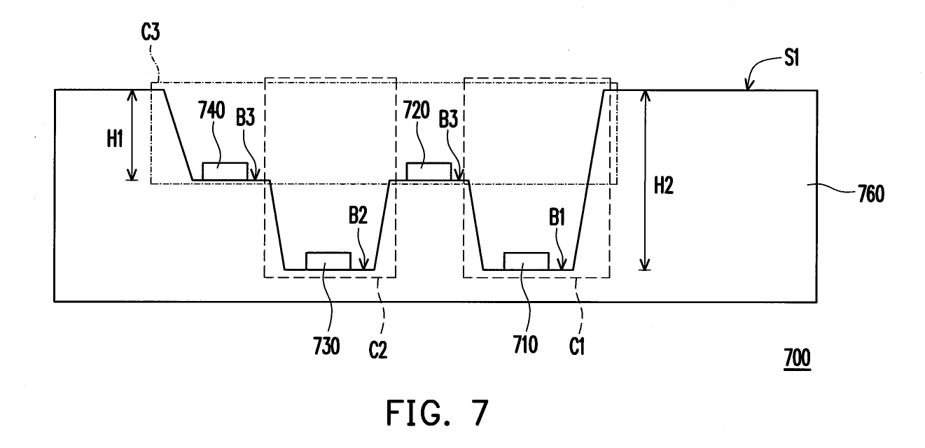

FIG. 7 is a diagram of an LED package structure of the variable-CCT LED light source module in FIG. 1A. Referring to FIG. 1A and FIG. 7, in the embodiment, the LED package structure 700 includes a substrate 760 and a plurality of LED chips 710, 720, 730, and 740.

In the embodiment, the substrate 760 includes a plurality of recesses C1, C2, and C3. Herein the top surface S1 of the substrate 760 and the bottom surfaces of the recesses define the corresponding recesses. For example, the recess C1 is defined by the top surface S1 and the bottom surface B1, the recess C2 is defined by the top surface S1 and the bottom surface B2, and the recess C3 is defined by the top surface S1 and the bottom surface B3. In the embodiment, the distance between the bottom surface of each recess and the top surface S1 of the substrate 760 is referred to as a recess depth, and the recesses may have the same or different recess depths. For example, the distances (recess depths) from the bottom surface B1 of the recess C1 and the bottom surface B2 of the recess C2 to the top surface S1 of the substrate 760 are both H1 (i.e., the two recess depths are the same), while the distance (recess depth) from the bottom surface B3 of the recess C3 to the top surface S1 of the substrate 760 is H2, which is different from foregoing recess depth H1.

It should be noted that in an exemplary embodiment of the disclosure, each recess may include a plurality of containing spaces for putting a packaging material, such as a wavelength conversion material (for example, phosphor), epoxy, or silicone. A containing space for putting the packaging material can be considered as a space defined by the minimum depth difference between the bottom surface of a specific recess and a higher bottom surface of an adjacent recess. If there is no bottom surface higher than the specific bottom surface, the containing space can be considered as a space defined by the recess depth. Thus, after putting a specific packaging material into the containing spaces, the containing spaces put into the packaging material form a vertical stack pattern. Besides, in the embodiment, the containing spaces of different recesses may be partially or completely connected with each other. In another embodiment, the bottom surface B3 may be at the same height as the top surface S1 of the substrate 760, so that the substrate 760, for example, simply includes the recess C1 and C2 which are not connected with each other. Different recess depths make the transmission path of the light beam emitted by a chip to be different from the working path of phosphor and make the light colors to be different.

In the embodiment, each LED chip is disposed in the corresponding recess. Each containing space is respectively put into the corresponding wavelength conversion material, epoxy, or silicon. When an LED chip is excited, it emits a corresponding light beam. Herein the light beams pass through the corresponding packaging materials to produce the first white light W and the broad-spectrum red light R, the green light G, and the blue light B (i.e., the second white light), as the light source blocks illustrated in FIG. 1A. Thus, after the first white light W and the second white light are mixed, a third white light W′ having a high CRI is produced. In the embodiment, the CRI of the third white light is greater than the CRI of the first white light and the CRI of the second white light, and the color coordinate of the third white light are different from the color coordinate of the first white light and the color coordinate of the second white light.

In the embodiment, after the light beams emitted by the LED chips 710, 720, 730, and 740 pass through the corresponding packaging materials, the first white light W and the broad-spectrum red light R, the green light G, and the blue light B are respectively produced. Herein the broad-spectrum red light R may be a broad-spectrum red light produced by mixing narrow-spectrum red lights or a broad-spectrum red light produced through phosphor conversion. In other words, in the embodiment, even though there are three recesses C1, C2, and C3, it is not each recess that produces a broad-spectrum monochromatic light through wavelength conversion.

The LED chip 710 may be a blue LED chip, and the white LED light source 110 includes the blue LED chip and a wavelength conversion layer. Herein after the containing space of the recess C1 is put into a wavelength conversion material, the blue LED chip emits a blue light when it is excited, and the blue light passes through the layered structure to produce the first white light W. For example, when the blue light passes through the wavelength conversion layer, a green light and a red light are respectively emitted, and the first white light is produced when the green light and the red light are mixed with the blue light. Or, when the blue light passes through the wavelength conversion layer, a yellow light, a green light, and a red light are respectively emitted, and the first white light is produced when the yellow light, the green light, and the red light are mixed with the blue light. Or, when the blue light passes through the wavelength conversion layer, a yellow light and a red light are respectively emitted, and the first white light is produced when the yellow light and the red light are mixed with the blue light. Or, when the blue light passes through the wavelength conversion layer, a yellow light is emitted, and the first white light is produced when the yellow light is mixed with the blue light. However, foregoing cases are only examples but are not intended to limit the disclosure. In another embodiment, the LED chip 710 may also be a UV LED chip, and the white LED light source 110 may include the UV LED chip and a wavelength conversion layer. The UV light passes through the wavelength conversion layer to produce the first white light W. In other words, the pattern and type of the LED chips in the white LED light source 110 are not limited in exemplary embodiments of the disclosure, and it is within the scope of the disclosure as long as the first white light W is produced after the lights emitted by the LED chips pass through the wavelength conversion layer.

On the other hand, in the embodiment, the LED chip 720 is a UV LED chip. In other words, in the embodiment, the LED light source 120 includes a UV LED chip and a corresponding wavelength conversion layer. When the UV LED chip is excited, it emits a UV light. The UV light passes through the corresponding wavelength conversion layer to produce a corresponding broad-spectrum monochromatic light. Taking a broad-spectrum red light as an example, the LED light source 120 includes a UV LED chip and a corresponding wavelength conversion layer, wherein the wavelength conversion layer may be a layered structure formed by different phosphors put into the containing spaces of the recess C3. Herein the materials of the phosphors are within the scope of the disclosure as long as a broad-spectrum red light is produced after a UV light passes through the materials.

It should be mentioned that in the embodiment, the optical characteristics (for example, peak wavelengths, FWHMs, brightness, and CCTs) of the first white light and the broad-spectrum monochromatic light are determined by at least the chip type, the recess depth, or one characteristic (for example, consistency, density, number, and type) of the wavelength conversion materials. Thus, in an exemplary embodiment of the disclosure, the package structure of the LED light source module 100 may be as that illustrated in FIG. 7, wherein a second white light having a high CRI can be produced by mixing the first white light with at least one broad-spectrum monochromatic light.

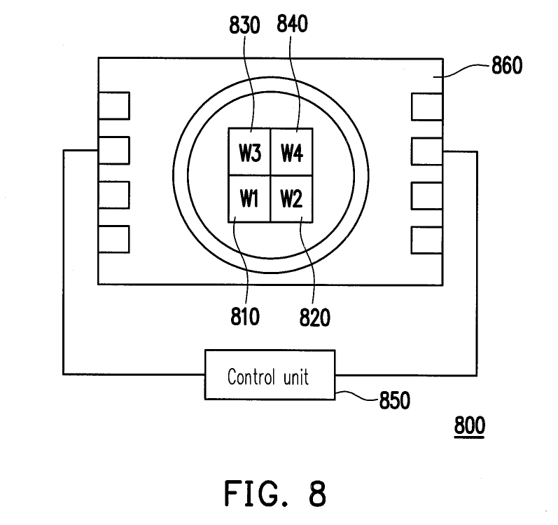

FIG. 8 is a diagram of a variable-CCT LED light source module according to another embodiment of the disclosure. Referring to FIG. 8, in the embodiment, the LED light sources 810, 820, 830, and 840 respectively include a UV LED chip and a red phosphor, a green phosphor, and a blue phosphor of different consistencies and emit four white lights W1-W4. In the embodiment, the LED light sources 810, 820, 830, and 840 are adjacently arranged on the substrate 860 as an array.

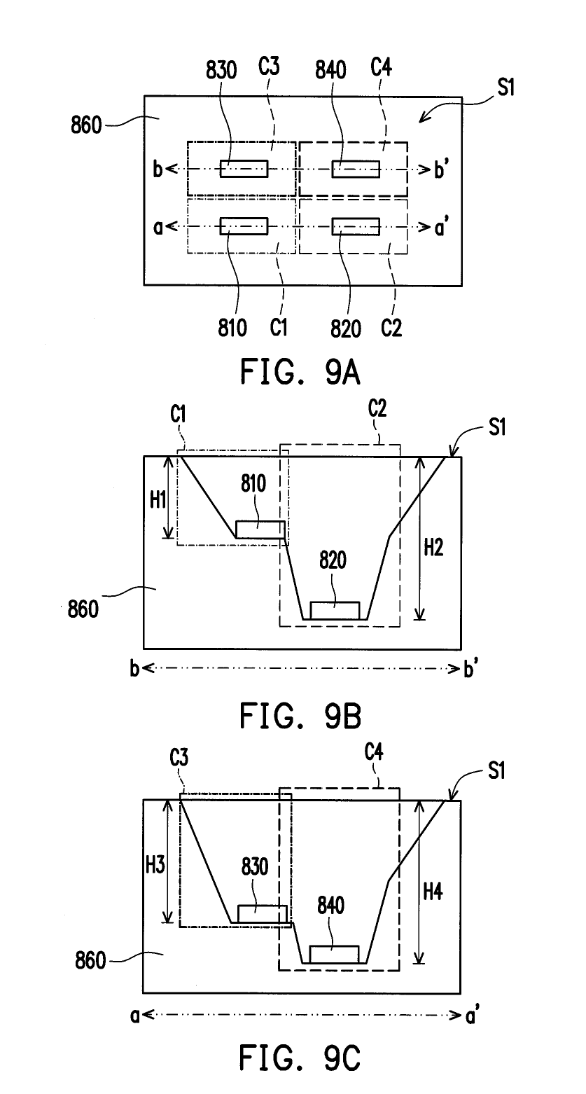

FIG. 9A is a top view of an LED package structure according to the embodiment illustrated in FIG. 8. FIG. 9B is a cross-sectional view of the LED package structure in FIG. 9A along line aa′, and FIG. 9C is a cross-sectional view of the LED package structure in FIG. 9A along line bb′. The difference between the embodiment and foregoing embodiments is that the recesses are adjacent to each other and arranged as an array and have different recess depths.

Referring to FIG. 8 and FIG. 9A-FIG. 9C, in the embodiment, the substrate 860 has four recesses C1-C4, the UV LED chips 810, 820, 830, and 840 are respectively disposed on the bottom surfaces of the recesses C1-C4, and the depths of the recesses C1-C4 are respectively H1-H4 (different from each other).

In the embodiment, the containing spaces of each recess can be put into blended phosphor (for example, including the red phosphor, the green phosphor, or the blue phosphor) having the same or different consistencies according to the corresponding UV LED chip 810, 820, 830, or 840. Because the UV light beams emitted by the UV LED chips pass through the containing spaces of the corresponding recesses via paths of different lengths, four different white lights W1-W4 are produced, as shown in FIG. 9B and FIG. 9C.

In another embodiment, the LED light sources 810, 820, 830, and 840 may be respectively a blue LED chip. Herein YAG phosphor having the same consistency is put into the containing spaces of the corresponding recesses to produce the four white lights W1-W4. It should be noted that in the embodiment, both blue LED chips and UV LED chips can be adopted at the same time. For example, the LED light sources 810 and 830 are both blue LED chips, and the LED light sources 820 and 840 are both UV LED chips. In this case, YAG phosphor is put into the containing spaces of the recess C1 and C3. Because the recesses C1 and C3 have different depths H1 and H3, light beams emitted by the LED light sources 810 and 830 have different working paths after they pass through the phosphor, and accordingly the white lights W1 and W3 having different color coordinates are produced. Regarding the recesses C2 and C4, blended phosphor (blue, green, and red phosphor) is put into the containing spaces thereof such that the light beams emitted by the UV LEDs can be modulated into the white lights W2 and W4 having different color coordinates.

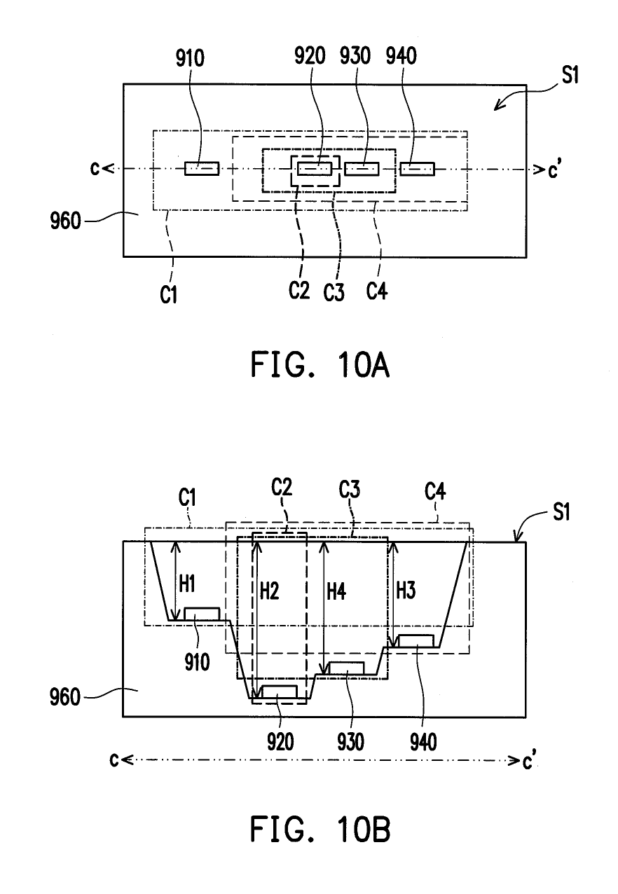

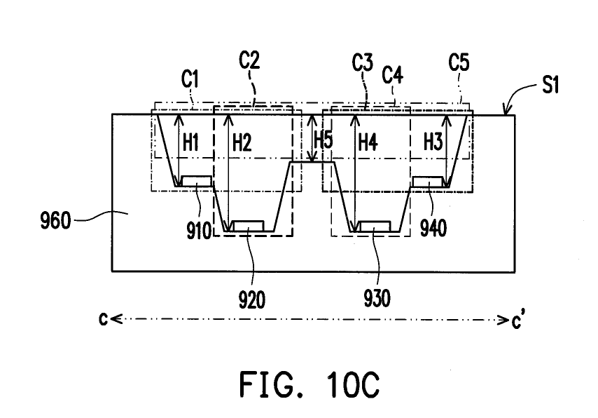

Additionally, in the embodiment, the different white lights may also be produced by using different types of chips, different phosphors in a phosphor layer, and the optional phosphor layer instead of by using the containing spaces as in FIG. 7, FIG. 9B, or FIG. 9C. Taking the light source module shown in FIG. 8 as an example, the substrate 860 may be a high thermal conductive substrate having no recess, such as aluminium nitride substrate, alumina substrate, copper substrate, silicon substrate, polychlorinated biphenyl (PCB) substrate, and etc. On the substrate 860, a plurality of light emitting dies are disposed adjacent to each other to form multi-chip in one package. Regarding the number of the disposed light emitting dies, at least two dies may be adopted to form the multi-chip in one package with variable-CCT. The four dies 810, 820, 830, and 840 as shown in FIG. 8 are one of the exemplary embodiments, and the invention is not limited thereto. For the CCT modulating method, the peak wavelengths of the lights emitted by each of the dies may be the same. For example, the peak wavelengths of the lights emitted by the dies 810 and 820 are both located within the same blue band, and the surface thereof are coated with phosphors of different consistencies and recipes, such as YAG phosphors. Accordingly, the lights emitted by the dies respectively excite corresponding YAG phosphors, and the first white light W1 and the second white light W2 are produced. Herein, color temperatures and color coordinates of the first white light W1 and the second white light W2 are different from each other. The ratio of each of the white lights can be adjusted by the control unit 850, and the adjusted parameters may be one of the currents, the spectrum, and the pulse width. In such a case, the CCT modulating function of multi-chip in one package is achieved. The specific number of the dies for the CCT modulating may be four, and the first white light W1, the second white light W2, the third white light W3, and the fourth white light W4 can be produced from each of the dies by utilizing the foregoing producing method. The color temperatures of these produced white lights are also different from each other. The ratio of each of the white lights can be adjusted by utilizing the foregoing adjusting method to achieve the CCT modulating function of multi-chip in one package. It should be noted that, the more the number of the dies for CCT modulating is, the more the type of the white lights with different temperatures to be produced is. Accordingly, the range of the CCT modulating becomes wider. Furthermore, at least one part of the dies can be the dies emitting UV lights, and by coating with corresponding phosphors, the white lights for CCT modulating are produced while the coated phosphors are excited. FIG. 10A is a top view of an LED package structure according to another embodiment of the disclosure. Referring to FIG. 10A, unlike the embodiments described above, in the embodiment, the LED light sources 910, 920, 930, and 940 are arranged into a row on the substrate 960, and the recesses have different depths. FIG. 10B is a cross-sectional view of the LED package structure in FIG. 10A along line cc′.

Referring to FIG. 10A and FIG. 10B, in the embodiment, the LED light sources 910, 920, 930, and 940 may be all UV LED chips along with blended phosphor or all blue LED chips along with YAG phosphor. Because the recess depths H1-H4 are all different from each other, the UV light beams emitted by the UV LED chips pass through the wavelength conversion materials in the containing spaces via paths of different lengths. Accordingly, four different white lights W1-W4 are produced.

Additionally, in the embodiment, the LED light sources 910, 920, 930, and 940 may be partially UV LED chips along with blended phosphor or partially blue LED chips along with YAG phosphor. For example, the LED light sources 920 and 940 are UV LED chips along with blended phosphor, and the LED light sources 910 and 930 are blue LED chips along with YAG phosphor.

Or, two of the LED light sources 910, 920, 930, and 940 are respectively a UV LED chip along with blended phosphor and a blue LED chip along with YAG phosphor, while the other two LED light sources are two UV LED chips along with blended phosphor, two blue LED chips along with YAG phosphor, or a UV LED chip along with blended phosphor and a blue LED chip along with YAG phosphor.

FIG. 10C illustrates another implementation of the LED package structure in FIG. 10A, wherein a cross-sectional view of the LED package structure in FIG. 10A is illustrated along line cc′. Referring to FIG. 10C, in the embodiment, the depths H1 and H3 of the recesses C1 and C3 are the same, and the depths H2 and H4 of the recesses C2 and C4 are the same. One feature of the embodiment is that the recess depths are partially equal.

In the embodiment, the LED light sources 920 and 930 are UV LED chips along with blended phosphor, and the LED light sources 910 and 940 are blue LED chips along with YAG phosphor. Even though the LED light sources 920 and 930 are both UV LED chips along with blended phosphor, because the UV light beams emitted by the corresponding UV LED chips pass through phosphor layers of different consistencies and types, two different white lights W2 and W3 are produced. Similarly, even though the LED light sources 910 and 940 are both blue LED chips along with YAG phosphor, because the blue light beams emitted by the corresponding blue LED chips pass through phosphor layers of different consistencies and types, two different white lights W1 and W4 are produced. Or, two chips which are of the same type and have different peak wavelengths may be adopted such that two different color lights are produced when phosphors having the same consistency and type are excited.

Thereby, in the embodiment, four different white lights W1-W4 can be produced according to the design requirement through control of the recess depths and adjustment of the types of the chips and the phosphors.

In the embodiment, a recess C5 may be designed as a protection layer according to the actual requirement. For example, the recess C5 may be a glass sheet for preventing leakage of the UV light beams. Besides, in the embodiment, in order to allow the LED light source module to have good optical characteristics, a layer of optical coating may be applied at the chips such that the UV light beams and the blue light beams at a specific wavelength are reflected back into the package while visible light is allowed to pass through.

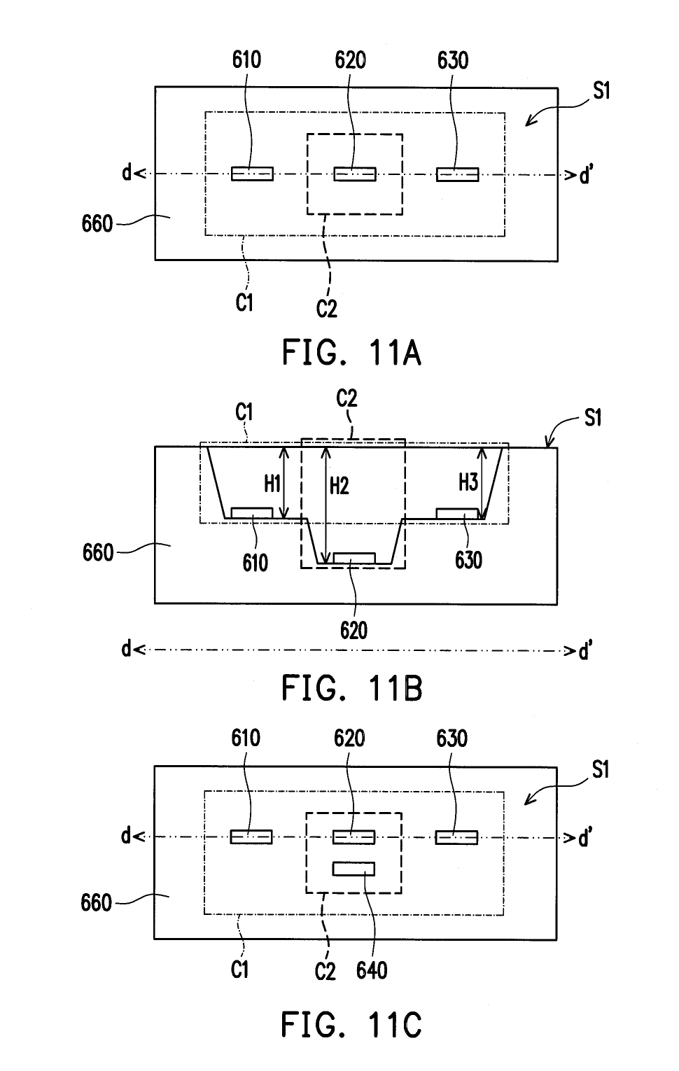

FIG. 11A is a top view of an LED package structure according to another embodiment of the disclosure. Referring to FIG. 11A, in the embodiment, the LED light sources 610, 620, and 630 are arranged into a row on the substrate 660. FIG. 11B is a cross-sectional view of the LED package structure in FIG. 11A along line dd′. Unlike the embodiments described above, in the embodiment, multiple LED chips may be disposed in a single recess, and the number of chips may not match the number of recesses.

Referring to FIG. 11A and FIG. 11B, in the embodiment, the LED light sources 610 and 630 are disposed in the recess C1, and the LED light source 620 is disposed in the recess C2. FIG. 11C is a top view of an LED package structure according to another embodiment of the disclosure. Referring to FIG. 11C, in the embodiment, an LED light source 640 is further disposed in the recess C2.

Based on the exemplary embodiment illustrated in FIG. 11A-FIG. 11C, one or more LED light sources may be disposed in the recesses of the substrate 660. In FIG. 11C, when multiple LED light sources are disposed in the recesses having the same depth, the peak wavelengths of the lights emitted by these LED light sources may be partially different. For example, the LED light sources disposed in the recess C2 may be blue LED chips along with YAG phosphor. Thus, the peak wavelengths of the lights emitted by these blue LED chips may be partially different so that white lights having different color coordinates can be produced. Similarly, the LED light sources disposed in the recess C1 may be UV LED chips along with blended phosphor or blue LED chips along with YAG phosphor. If two LED light sources (LED light sources 610 and 630) are disposed in the recess C1, the peak wavelengths of the lights emitted by these two LED light sources may also be different.

At least two white lights that have different color coordinates can be produced based on the LED package structure described above.

It should be noted that in the embodiment, LED chips having the same peak wavelength may also be disposed in the recesses having the same depth, and the number of lumens can be increased by adopting multiple LED chips according to the brightness requirement of an illuminated environment. Besides, in the embodiment, the LED light sources 610 and 640 may be white light sources, and the LED light sources 620 and 630 may be two monochromatic light sources having different peak wavelengths, such as a first red LED light source and a second red LED light source. Herein no wavelength conversion material is put into the containing spaces of the recess C1, and a broad-spectrum monochromatic light is produced by adding up the spectra of the two monochromatic lights, so as to change the CCT or CRI of the white light source.

It should be noted that in the embodiments illustrated in FIG. 7-FIG. 11C, the number and depths of the recesses, the types of the phosphors, and the technique for producing the broad-spectrum monochromatic light and white lights are only examples but not intended to limit the scope of the disclosure.

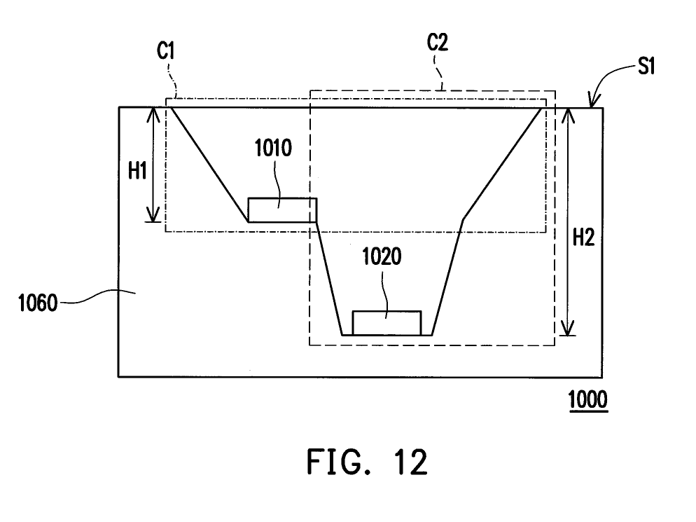

FIG. 12 is a diagram of an LED package structure according to another embodiment of the disclosure. Referring to FIG. 12, in the embodiment, the LED package structure 1000 includes a substrate 1060 and a plurality of LED chips 1010 and 1020. Herein the substrate 1060 has at least two recesses C1 and C2.

In the embodiment, the LED chips 1010 and 1020 emit a first white light and a second white light, a first white light and a broad-spectrum monochromatic light, or at least two monochromatic lights having different peak wavelengths. In the embodiment, the broad-spectrum monochromatic light and the white lights are produced by guiding light beams through the corresponding wavelength conversion material or by mixing monochromatic lights having different peak wavelengths.

For example, the LED chip 1020 is a UV LED chip which emits a UV light beam, and a blended phosphor composed of red phosphor, blue phosphor, and green phosphor is put into the containing spaces of the recess C2. The first white light can be produced by exciting the blended phosphor with the UV light beam. The LED chip 1010 is a blue LED chip which emits a blue light beam, and YAG phosphor is put into the containing spaces of the recess C1. The second white light can be produced by exciting the YAG phosphor with the blue light beam, and a third white light can be produced by mixing the first white light and the second white light, wherein the color coordinate of the third white light are different from those of the first white light and the second white light, and the CRI of the third white light is greater than that of the first white light or the second white light.

It should be noted that the same type of chips may be disposed in two recesses having different depths. For example, the LED chips 1010 and 1020 are both blue LED chips, and YAG phosphor is put into the containing spaces of both the recesses C1 and C2. Because the light beams emitted by the LED chips have different working paths after they pass through the phosphor, a first white light and a second white light are produced. Besides, a third white light is produced by mixing the first white light and the second white light, wherein the color coordinate of the third white light are different from those of the first white light and the second white light, and the CRI of the third white light is higher than that of the first white light or the second white light. Moreover, the LED chips 1010 and 1020 may be both UV LED chips, and a blended phosphor may be put into the containing spaces of both the recesses C1 and C2, which will not be described herein.

Because the color coordinates of the first white light and the second white light are different from each other, the current or pulse width respectively supplied to the LED chips 1010 and 1020 may be changed through a control unit (not shown) so as to produce the third white light.

In another implementation pattern, the LED chip 1020 is designed into a white light source (the technique for producing a white light has been described above therefore will not be described herein), and the light beam emitted by the LED chip 1010 is modulated into a broad-spectrum monochromatic light (for example, a broad-spectrum red light is produced by guiding the light beam through the recess C1). The broad-spectrum red light may be produced by guiding the light beam emitted by the LED chip 1010 through the wavelength conversion material corresponding to the recess C1 or by mixing monochromatic lights having different peak wavelengths. If the broad-spectrum red light is produced by mixing monochromatic lights having different peak wavelengths, the LED chip 1010 may be composed of a plurality of dies (not shown), and the material put into the containing spaces of the recess C1 may be epoxy or silicon such that the reliability of the package structure can be enhanced.

Similarly, in yet another implementation pattern, the LED chip 1020 is designed as a blue LED chip. A high-consistency yellow or orange phosphor may be put into the containing spaces of the recess C2 such that the blue light can fully react with the phosphor to produce a first white light and accordingly the peak wavelength of the blue light in a medium- to high-CCT light source spectrum can be reduced. In addition, the LED chip 1010 is designed as a green LED chip such that the color coordinate and CCT of the first white light can be adjusted to be within a predetermined range. Herein silicon or epoxy can be selectively put into the containing spaces of the recesses to protect the chips and filling materials. Or, a highly flowable and transparent heat dissipation fluid (for example, silicon oil or ionized water) doped with scattering particles (for example, TiO₂) may also be put into the containing spaces of the recesses to enhance the heat dissipation capability of the package structure and the color uniformity of the mixed light.

In a similar implementation pattern, the LED chips 1010 and 1020 may also emit two monochromatic lights having different peak wavelengths and be disposed in the recesses having different depths, and a packaging material (for example, a wavelength conversion material, epoxy, or silicone) or a highly heat-conductive transparent fluid (for example, silicon oil or ionized water, may be doped with scattering particles) may be selectively put into the containing spaces of the recess C1 or C2. This implementation pattern is similar to that described above therefore will not be described herein.

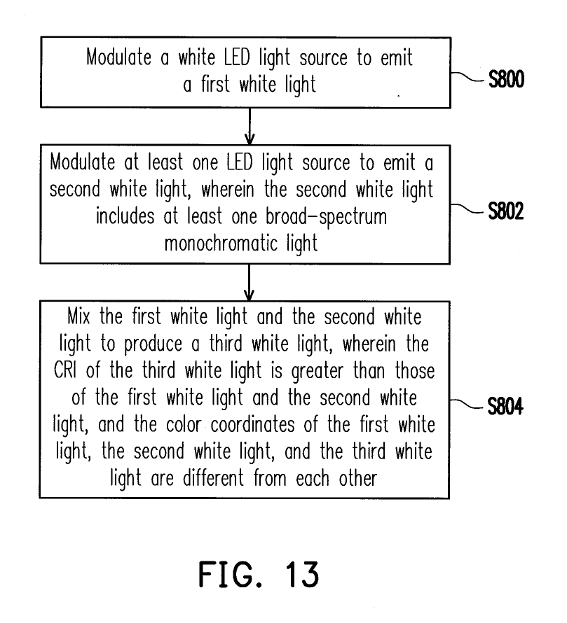

FIG. 13 is a flowchart of a CCT modulating method according to an embodiment of the disclosure. Referring to both FIG. 1A and FIG. 13, the CCT modulating method in the embodiment includes following steps. First, in step S800, a white LED light source 110 is modulated to emit a first white light W. Then, in step S802, LED light sources 120, 130, and 140 are modulated to emit a second white light, wherein the second white light includes at least one broad-spectrum monochromatic light. Next, in step S804, the first white light W and the second white light are mixed to produce a third white light W′. Herein the CRI of the third white light is greater than those of the first white light and the second white light, and the color coordinates of the three white lights are different from each other.

Additional aspects and advantages of the CCT modulating method provided by an embodiment of the disclosure will be obvious from the descriptions of the embodiments illustrated in FIG. 1A-FIG. 12 therefore will not be described herein.

In summary, in an exemplary embodiment of the disclosure, an LED light source module mixes a constant white light and a modulated white light through a CCT modulating method, so as to produce a white light having a high CRI and achieve a color tuning purpose. Moreover, if an illumination application requires a high-quality white light, an LED light source module can provide a white light having a high CRI through the CCT modulating method provided by the disclosure.

It will be apparent to those skilled in the art that various modifications and variations can be made to the structure of the disclosed embodiments without departing from the scope or spirit of the disclosure. In view of the foregoing, it is intended that the disclosure cover modifications and variations of this disclosure provided they fall within the scope of the following claims and their equivalents.

What is claimed is:

1. A correlated color temperature (CCT) modulating method, comprising:
modulating a white light emitting diode (LED) light source to emit a first white light;
modulating at least one LED light source to emit at least one broad-spectrum monochromatic light; and
mixing the first white light and the broad-spectrum monochromatic light to produce a second white light, wherein a color rendering index (CRI) of the second white light is greater than a CRI of the first white light, and a color coordinate of the first white light are different from a color coordinate of the second white light.

2. The CCT modulating method according to claim 1, wherein the LED light source comprises a plurality of monochromatic LED light sources, and the step of modulating the LED light source comprises:
modulating the monochromatic LED light sources to emit at least two monochromatic lights; and
mixing the monochromatic lights to produce the broad-spectrum monochromatic light.

3. The CCT modulating method according to claim 2, wherein the monochromatic lights comprise a first monochromatic light and a second monochromatic light, wavelengths corresponding to 1/10^{th} of an intensity of a peak wavelength of the first monochromatic light are respectively λ1 and λ2, and wavelengths corresponding to 1/10^{th} of an intensity of a peak wavelength of the second monochromatic light are respectively λ3 and λ4, wherein λ2>λ1, λ4>?3, λ4>λ1, and λ2≧λ3.

4. The CCT modulating method according to claim 1, wherein the LED light source comprises an LED chip and a wavelength conversion layer, and the step of modulating the LED light source comprises:
exciting the LED chip to generate a light beam; and
allowing the light beam to pass through the wavelength conversion layer to generate the broad-spectrum monochromatic light.

5. The CCT modulating method according to claim 4, wherein a full width half maximum (FWHM) of the broad-spectrum monochromatic light is greater than an FWHM of the light beam.

6. A CCT modulating method, comprising:
modulating a white LED light source to emit a first white light;
modulating at least one LED light source to emit a second white light, wherein the second white light comprises at least one broad-spectrum monochromatic light; and
mixing the first white light and the second white light to produce a third white light.

7. The CCT modulating method according to claim 6, wherein a CRI of the third white light is greater than a CRI of the first white light and a CRI of the second white light, and color coordinates of the first white light, the second white light, and the third white light are different from each other.

8. The CCT modulating method according to claim 6, wherein the LED light source comprises a plurality of monochromatic LED light sources, and the step of modulating the LED light source comprises:
modulating the monochromatic LED light sources to emit a plurality of monochromatic lights;
mixing the monochromatic lights to produce the broad-spectrum monochromatic light; and
mixing the monochromatic lights and the broad-spectrum monochromatic light to produce the second white light.

9. The CCT modulating method according to claim 8, wherein the monochromatic lights comprise a first monochromatic light and a second monochromatic light, wavelengths corresponding to 1/10^{th} of an intensity of a peak wavelength of the first monochromatic light are respectively λ1 and λ2, and wavelengths corresponding to 1/10^{th} of an intensity of a peak wavelength of the second monochromatic light are respectively λ3 and λ4, wherein λ2>λ1, λ4>λ3, λ4>λ1, and λ2≧λ3.

10. The CCT modulating method according to claim 6, wherein the LED light source comprises an LED chip and a wavelength conversion layer, and the step of modulating the LED light source comprises:
exciting the LED chip to generate a light beam; and
allowing the light beam to pass through the wavelength conversion layer to generate the broad-spectrum monochromatic light.

11. The CCT modulating method according to claim 10, wherein an FWHM of the broad-spectrum monochromatic light is greater than an FWHM of the light beam.

12. The CCT modulating method according to claim 6, wherein the step of modulating the LED light source comprises:
modulating at least one of a current and a pulse width parameter of the LED light source to emit the broad-spectrum monochromatic light.

13. The CCT modulating method according to claim 6, wherein the step of modulating the white LED light source comprises:
modulating at least one of a current and a pulse width parameter of the white LED light source to emit the first white light.

14. A variable-CCT LED light source module, comprising:
a white LED light source emitting a first white light;
at least one LED light source emitting at least one broad-spectrum monochromatic light; and
a control unit exciting the white LED light source and the LED light source to emit the first white light and the broad-spectrum monochromatic light, wherein the first white light and the broad-spectrum monochromatic light form a second white light, a CRI of the second white light is greater than a CRI of the first white light, and a color coordinate of the first white light are different from a color coordinate of the second white light.

15. The LED light source module according to claim 14, wherein the LED light source comprises a plurality of monochromatic LED light sources, and the control unit excites the monochromatic LED light sources to emit at least two monochromatic lights and mixes the monochromatic lights to produce the broad-spectrum monochromatic light.

16. The LED light source module according to claim 15, wherein the monochromatic lights comprise a first monochromatic light and a second monochromatic light, wavelengths corresponding to 1/10^{th} of an intensity of a peak wavelength of the first monochromatic light are respectively λ1 and λ2, and wavelengths corresponding to 1/10^{th} of an intensity of a peak wavelength of the second monochromatic light are respectively λ3 and λ4, wherein λ2>λ1, λ4>λ3, λ4>λ1, and λ2≧λ3.

17. The LED light source module according to claim 14, wherein the LED light source comprises an LED chip and a wavelength conversion layer, and the control unit excites the LED chip to generate a light beam and allows the light beam to pass through the wavelength conversion layer to generate the broad-spectrum monochromatic light.

18. The LED light source module according to claim 17, wherein an FWHM of the broad-spectrum monochromatic light is greater than an FWHM of the light beam.

19. A variable-CCT LED light source module, comprising:
a white LED light source emitting a first white light;
at least one LED light source emitting a second white light, wherein the second white light comprises at least one broad-spectrum monochromatic light; and
a control unit exciting the white LED light source and the LED light source to emit the first white light and the second white light, wherein the first white light and the second white light form a third white light.

20. The LED light source module according to claim 19, wherein a CRI of the third white light is greater than a CRI of the first white light and a CRI of the second white light, and color coordinates of the first white light, the second white light, and the third white light are different from each other.

21. The LED light source module according to claim 19, wherein the LED light source comprises a plurality of monochromatic LED light sources, the control unit excites the monochromatic LED light sources to emit a plurality of monochromatic lights, mixes the monochromatic lights to produce a first broad-spectrum monochromatic light, and mixes the monochromatic lights and the first broad-spectrum monochromatic light to produce the second white light.

22. The LED light source module according to claim 21, wherein the monochromatic lights comprise a first monochromatic light and a second monochromatic light, wavelengths corresponding to 1/10^{th} of an intensity of a peak wavelength of the first monochromatic light are respectively λ1 and λ2, wavelengths corresponding to 1/10^{th} of an intensity of a peak wavelength of the second monochromatic light are respectively λ3 and λ4, wherein λ2>λ1, λ4>λ3, λ4>λ1, and λ2≧λ3.

23. The LED light source module according to claim 19, wherein the LED light source comprises an LED chip and a wavelength conversion layer, and the control unit excites the LED chip to generate a light beam and allows the light beam to pass through the wavelength conversion layer to generate a second broad-spectrum monochromatic light.

24. The LED light source module according to claim 23, wherein an FWHM of the second broad-spectrum monochromatic light is greater than an FWHM of the light beam.

25. The LED light source module according to claim 19, wherein a color temperature and the color coordinate of the first white light are adjustable.

26. An LED package structure, comprising:
a substrate comprising a plurality of recesses, wherein the recesses comprise a plurality of recess depths, and at least part of the recess depths are different from each other; and
a plurality of LED chips, disposed in the recesses, wherein each of the LED chips emits a corresponding light beam,
wherein at least one first white light and at least one second white light are produced after the light beams pass through the recesses;
wherein color coordinates of the second white light and the first white light are different from each other.

27. The LED package structure according to claim 26, wherein the first white light or the second white light comprises at least one broad-spectrum monochromatic light.

28. The LED package structure according to claim 27, wherein at least two monochromatic lights are produced after the light beams pass through the recesses, and the monochromatic lights form the broad-spectrum monochromatic light.

29. The LED package structure according to claim 28, wherein the monochromatic lights comprise a first monochromatic light and a second monochromatic light, wavelengths corresponding to 1/10^{th} of an intensity of a peak wavelength of the first monochromatic light are respectively λ1 and λ2, and wavelengths corresponding to 1/10^{th} of an intensity of a peak wavelength of the second monochromatic light are respectively λ3 and λ4, wherein λ2>λ1, λ4>λ3, λ4>λ1, and λ2≧λ3.

30. The LED package structure according to claim 27, wherein a wavelength conversion material is put into at least one of the recesses, and the broad-spectrum monochromatic light is produced after at least one of the light beams passes through the recess.

31. The LED package structure according to claim 30, wherein an FWHM of the broad-spectrum monochromatic light is greater than an FWHM of the light beam.

32. The LED package structure according to claim 26, wherein the substrate comprises a top surface, each of the recesses has a bottom surface, and the top surface and the bottom surfaces respectively define the recesses.

33. The LED package structure according to claim 27, wherein optical characteristics of the first white light, the second white light, and the broad-spectrum monochromatic light are determined by at least one of the recess depths and the LED chips.

34. The LED package structure according to claim 30, wherein optical characteristics of the first white light, the second white light, and the broad-spectrum monochromatic light are determined by at least one of the recess depths, the LED chips, and the wavelength conversion material.

35. An LED package structure, comprising:
a substrate, comprising a plurality of recesses, wherein the recesses comprise a plurality of recess depths, and at least part of the recess depths are different from each other; and
a plurality of LED chips, disposed in the recesses, wherein each of the LED chips emits a corresponding light beam,
wherein at least one first white light and at least one broad-spectrum monochromatic light are produced after the light beams pass through the recesses.

36. The LED package structure according to claim 35, wherein at least two monochromatic lights are produced after the light beams pass through the recesses, and the monochromatic lights form the broad-spectrum monochromatic light.

37. The LED package structure according to claim 36, wherein the monochromatic lights comprise a first monochromatic light and a second monochromatic light, wavelengths corresponding to 1/10^{th} of an intensity of a peak wavelength of the first monochromatic light are respectively λ1 and λ2, and wavelengths corresponding to 1/10^{th} of an intensity of a peak wavelength of the second monochromatic light are respectively λ3 and λ4, wherein λ2>λ1, λ4>λ3, λ4>λ1, and λ2≧λ3.

38. The LED package structure according to claim 35, wherein a wavelength conversion material is put into at least one of the recesses, and the broad-spectrum monochromatic light is produced after at least one of the light beams passes through the recess.

39. The LED package structure according to claim 38, wherein an FWHM of the broad-spectrum monochromatic light is greater than an FWHM of the light beam.

40. The LED package structure according to claim 35, wherein the substrate comprises a top surface, each of the recesses has a bottom surface, and the top surface and the bottom surfaces respectively define the recesses.

41. The LED package structure according to claim 35, wherein optical characteristics of the first white light and the broad-spectrum monochromatic light are determined by at least one of the recess depths and the LED chips.

42. The LED package structure according to claim 38, wherein optical characteristics of the first white light and the broad-spectrum monochromatic light are determined by at least one of the recess depths, the LED chips, and the wavelength conversion material.

43. An LED package structure, comprising:
a substrate comprising at least two recesses, wherein the recesses have different depths; and
a plurality of LED chips respectively disposed in the recesses, wherein the LED chips emit at least one first light beam and at least one second light beam,
wherein the first light beam and the second light beam have different peak wavelengths.

44. The LED package structure according to claim 43, wherein the substrate comprises a top surface, each of the recesses has a bottom surface, and the top surface and the bottom surfaces respectively define the recesses.
